(19) United States
(12) Patent Application Publication
(10) Pub. No.: US 2006/0095939 A1
(43) Pub. Date: May 4, 2006

(54) Method and apparatus for the separation of data from digital broadcast signals for distribution via a computer network to clients

(76) Inventor: Curtis E. Jutzi, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/301,607

(22) Filed: Dec. 12, 2005

Related U.S. Application Data
(63) Continuation of application No. 09/607,292, filed on Jun. 30, 2000, now abandoned.

(51) Int. Cl. H04N 7/18; H04N 7/20

(52) U.S. Cl. 725/78; 725/74; 725/80; 725/71

(57) ABSTRACT

The present invention provides a method, apparatus, and system to separate data from a digital broadcast signal for distribution via a computer network to clients. A data separation device separates digital video information, digital audio information and digital data from a digital broadcast signal. The data separation device can be installed at a Network Operating Center (NOC) (e.g. a cable or broadcast NOC). A router coupled to the data separation device transmits the digital data to a computer network (e.g. the Internet) for access by a client receiver system. A digital-to-analog (D/A) converter converts the digital video and audio information into analog video and audio information, respectively, for transport to the client receiver system. The client receiver system can include a computer having a modem, as well as, a display (e.g. a TV or computer monitor). The computer receives the digital data from the computer network via the modem and displays the digital data in conjunction with the analog video and audio information on the display.

### BACKGROUND

1. Field of the Invention

This invention relates to communication systems. In particular, the invention relates to the separation of data from digital broadcast signals for distribution via a computer network to clients.

2. Description of Related Art

Currently, many television networks transmit their television programs from satellites, as a digital broadcast signal, to ground-based Network Operating Centers (NOCs), both cable NOCs and over-the-air broadcast NOCs. These NOCs aggregate and transmit the network's television programming to local television receivers. The digital broadcast signal includes audio and video (A/V) information (e.g. a television program), as well as, data. Many television networks digitally broadcast their television programs in new wide screen, high resolution formats known as high definition television (HDTV), as well as, in standard definition television (SDTV) formats that provide picture resolution similar to existing television service. Also, the digital broadcast signals include data that can be transmitted to a television simultaneously with the A/V information.

Most television networks broadcast their digital broadcast signal utilizing the Moving Pictures Experts Group (MPEG)-2 transport format that delivers a digital data stream in fixed-length “packets” of information. Each packet contains only one type of data: video, audio or ancillary (e.g. data). Further, many television networks transmit their digital broadcast signals in accordance with either Digital Video Broadcasting (DVB) standards set by the European Telecommunications Standards Institute or the Advanced Television System Committee (ATSC) standards (e.g. ATSC Modulation and Coding Requirements for Digital TV (DTV) Applications over Satellite A/80 standard (ATSC Doc. A/80, Jul. 17, 1999)). DVB standards specify the MPEG-2 format for video, audio, and transport. The ATSC Satellite standard specifies the MPEG-2 format for video, the Digital Audio Compression (AC-3) standard for audio, and identifies the MPEG-2 format as a means of transport, but it is not limited to this format.

Of particular interest, beyond the transmission of A/V information (i.e. the television program), is that these digital broadcast signals from the television networks include additional data that may carry any number of valuable assets. Particularly, the data portion of the digital broadcast signal may carry Advanced Television Enhancement Forum (ATVEF) content (e.g. graphics, video, text, audio, and other types of data) and Streaming Internet Protocol (IP) data (e.g. graphics, video, text, audio, and other types of data).

The ATVEF is a cross-industry group formed to specify a single public standard for delivering interactive television experiences that can be authored once using a variety of tools and deployed to a variety of television, set-top, and PC-based receivers. The ATVEF Standard (ATVEF Specification v1.1 r26 1999) specifies content formats (e.g. graphics, video, text, audio, and other types of data) and delivery mechanisms that provide enhanced television experiences. Specifically, the ATVEF includes a content specification that provides content creators with a reliable definition of mandatory content support on all compliant receivers.

Using this additional data transmission capability within the digital broadcast signal, television networks can transmit additional data content (e.g. ATVEF and IP data for e.g., graphics, video, text, audio, and other types of data) such as program schedules, information about products being advertised, information about sporting events and news events, or virtually any other type of information, at the same time that they transmit regular television programming. For example, a television network may transmit a financial news show (i.e. the A/V information from the digital broadcast signal) with an announcer talking about what happened to the stock market during the day, simultaneously, the broadcast station can transmit digital data (e.g. graphics, video, text, audio, and other types of data), such as streaming stock quotes, information about a company—e.g. a news story or a picture of the company headquarters, graphs, cartoons, or virtually any type of information, for example, in a window under the announcer.

Unfortunately, most ground-based Network Operating Centers (NOCs), both cable NOCs and over-the-air NOCs, that receive the television network's digital broadcast signal from a satellite can transmit only the A/V information (i.e. the basic television program), to local television receivers and not the digital data portion. In fact, most NOCs take the digital broadcast signal, convert it to an analog signal for transmission, and completely disregard the data portion of the digital broadcast signal. Even the few ATSC Digital TV NOCs that transmit the digital (A/V) information from the digital broadcast signal (e.g. television programs in HDTV format) do not have the equipment to also transmit the digital data from the digital broadcast signal to local-television receivers.

### BRIEF DESCRIPTION OF THE DRAWINGS

The features and advantages of the present invention will become apparent from the following description of the present invention in which:

FIG. 1 is a block diagram illustrating an exemplary environment in which an embodiment of the invention can be practiced.

FIG. 2 is a block diagram particularly illustrating a data separation device and a router installed within a Network Operating Center (NOC) according to one embodiment of the invention.

FIG. 3a is a diagram illustrating the data separation device installed within a Cable NOC and particularly illustrates a client receiver system according to one embodiment of the invention.

FIG. 3b is a diagram illustrating the data separation device installed within a Broadcast NOC and particularly illustrates the client receiver system according to one embodiment of the invention.

FIG. 4 is a flowchart illustrating a method to separate data from a digital broadcast signal for distribution via a computer network to a client receiver system according to one embodiment of the invention.

### DESCRIPTION

The present invention provides a method, apparatus, and system to separate the digital data portion of a digital broadcast signal for distribution via a computer network to clients. A data separation device separates digital video information, digital audio information and digital data from a digital broadcast signal. The data separation device can be installed at a Network Operating Center (NOC) (e.g. a cable or broadcast NOC). A router coupled to the data separation device transmits the digital data to a computer network (e.g. the Internet) for access by a client receiver system.

In one embodiment, a digital-to-analog (D/A) converter converts the digital audio and video information into analog audio and video (A/V) information, respectively, for transport to the client receiver system. The client receiver system can include a computer having a modem, as well as, a display (e.g. a TV or computer monitor). The computer receives the digital data from the computer network via the modem and displays the digital data either alone (e.g. a separate digital broadcast) or in conjunction with the analog (A/V) information on the display. Alternatively, the computer can also cache and store the digital data for later use.

In the following description, the various embodiments of the present invention will be described in detail. However, such details are included to facilitate understanding of the invention and to describe exemplary embodiments for implementing the invention. Such details should not be used to limit the invention to the particular embodiments described because other variations and embodiments are possible while staying within the scope of the invention. Furthermore, although numerous details are set forth in order to provide a thorough understanding of the present invention, it will be apparent to one skilled in the art that these specific details are not required in order to practice the present invention. In other instances details such as, well-known electrical structures and circuits, are shown in block diagram form in order not to obscure the present invention.

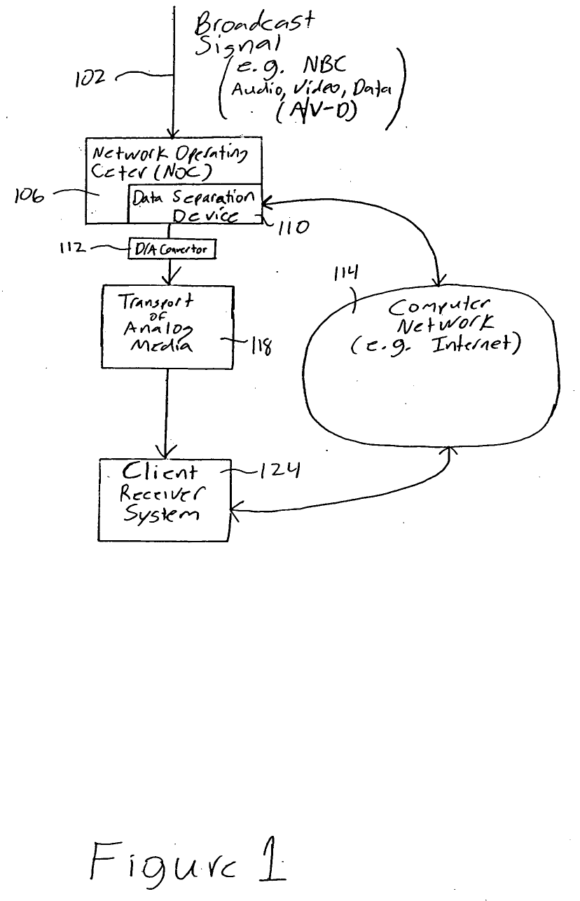

FIG. 1 is a block diagram illustrating an exemplary environment in which an embodiment of the invention can be practiced. As shown in FIG. 1, a television network (e.g. NBC) transmits a television program from a satellite, as a digital broadcast signal 102, to a ground-based Network Operating Center 106 (e.g. a cable or a broadcast NOC). Typically, a NOC aggregates and transmits the network's television programming to local television receivers. The digital broadcast signal 102 includes audio and video (A/V) information (i.e. a television program), as well as, data (A/V-D). Many television networks digitally broadcast their television programs in new wide screen high definition television HDTV formats, as well as, in standard definition television SDTV formats.

Most television networks broadcast their digital broadcast signal utilizing the MPEG-2 transport-format that delivers a digital data stream in fixed-length “packets” of information. Each packet contains only one type of data: video, audio or ancillary (e.g. data). Further, many television networks transmit their digital broadcast signals in accordance with either DVB standards or the ATSC Satellite standard. The DVB standard specifies the MPEG-2 format for video, audio, and transport. The ATSC standard specifies the MPEG-2 format for video, the Digital Audio Compression (AC-3) Standard for audio, and identifies the MPEG-2 format as a means of transport, but it is not limited to this format.

Of particular interest, beyond the transmission of A/V information (i.e. the television program) is that the digital broadcast signal 102 can include additional data that may carry any number of valuable assets. Particularly, the data portion of the digital broadcast signal 102 may carry Advanced Television Enhancement Forum (ATVEF) content (e.g. graphics, video, text, audio, and other types of data) and/or Streaming Internet Protocol (IP) data (e.g. graphics, video, text, audio, and other types of data). Using this additional data transmission capability within the digital broadcast signal 102, additional data content such as: program schedules, information about products being advertised, information about sporting events and news events, or virtually any other type of information, can be transmitted at the same time that they transmit regular television programming. Unfortunately, most present day Network Operating Centers (NOCs), can only transmit the A/V information (i.e. the basic television program), to local television receivers, and completely disregard the digital data portion of the digital-broadcast signal 102 so that it is unusable by client receiver systems.

The present invention provides a method, apparatus, and system to separate the digital data portion of the digital broadcast signal 102 for distribution via a computer network to clients such that it usable and readily accessible by clients. A data separation device 110 installed at the NOC 106 separates the digital video information, the digital audio information and the digital data from the digital broadcast signal 102 and transmits the digital data portion to a computer network 114 (e.g. the Internet) for access by a client receiver system 124.

In one embodiment, a digital-to-analog (D/A) converter 112 converts the digital audio and video information from the data separation device 110 into analog audio and video (A/V) information, respectively, for transport of the analog media 118 (e.g. by a broadcast or cable NOC) to a client receiver system 124. The client receiver system 124 receives the digital data from the computer network 114 and displays the digital data either alone (e.g. a separate digital broadcast) or in conjunction with the analog (A/V) information on a display. Alternatively, the client receiver system can cache and store the digital data for later use.

For example, if a television network transmits a financial news show (i.e. the A/V information from the digital broadcast signal) via the digital broadcast signal 102 having an announcer talking about what happened to the stock market during the day, as well as, digital data (e.g. graphics, video, text, audio, and other types of data), such as streaming stock quotes, information about a company—e.g. a news story or a picture of the company headquarters, graphs, etc., the digital data portion can be readily viewed by the client receiver system 124 simultaneously along with the traditional A/V information (i.e. the financial news show) utilizing the present invention.

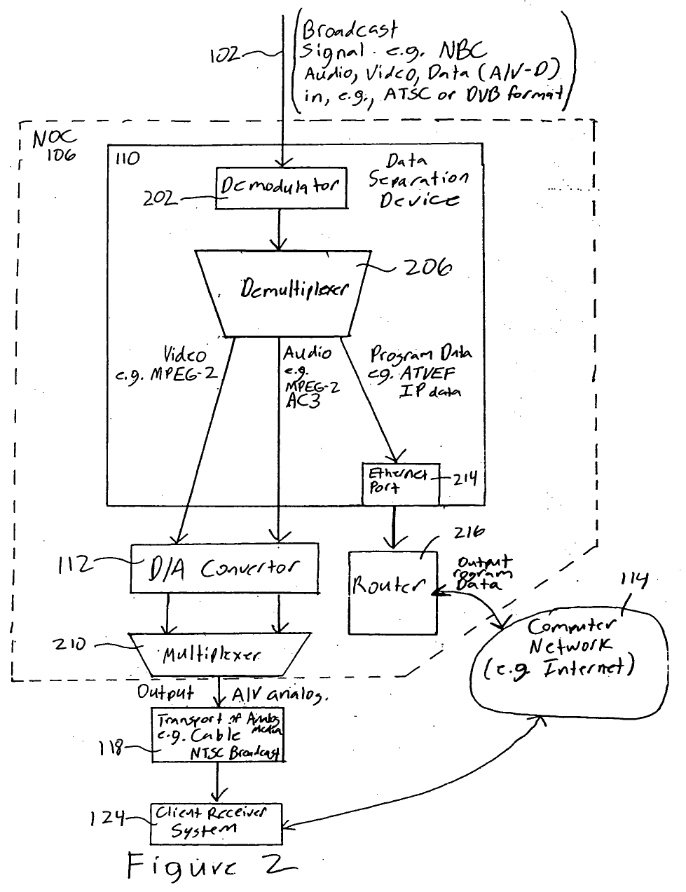

FIG. 2 is a block diagram particularly illustrating the data separation device 110 and a router installed within a Network Operating Center (NOC) 106 according to one embodiment of the invention. As shown in FIG. 2, the NOC 106 receives a digital broadcast signal 102 that includes digital A/V information (e.g. a television program) and digital data (A/V-D) in, for example, an ATSC or DVB format. The data separation device 110, as will be discussed, separates the digital data portion of the digital broadcast signal 102 and enables it to be transmitted to a computer network 114 for access by a client receiver system 124. The data separation device 110 includes a demodulator 202, a demultiplexer 206, and an Ethernet port 214.

The demodulator 202 first demodulates the digital broadcast signal 102 from a carrier frequency. Further, as shown in FIG. 2, the demultiplexer 206 separates the digital video information (e.g. MPEG-2), the digital audio information (e.g. MPEG-2 or AC-3), and the digital program data (e.g. ATVEF or IP data), respectively, from the digital broadcast signal 102. An Ethernet port 214 couples the data separation device 110 to a router 216 and transmits the digital program data to the router 216. The router 216 transmits the digital program data to a computer network 114 (e.g. the Internet) for access by the client receiver system 124. Alternatively, the router 216 can be part of the data separation device 110.

On the other hand, the digital-to-analog (D/A) converter 112 receives and converts the digital audio and video information into analog audio and video (A/V) information, respectively. The analog video and audio information can then be combined by, for example, multiplexer 210. The Network Operating System (NOC), such as a cable NOC or a broadcast NOC (e.g. a National Television Standards Committee (NTSC) broadcast NOC), transports the analog (A/V) information 118 to the client receiver system 124 where it is combined with the digital program data (e.g. graphics, video, text, audio, and other types of data), as previously discussed.

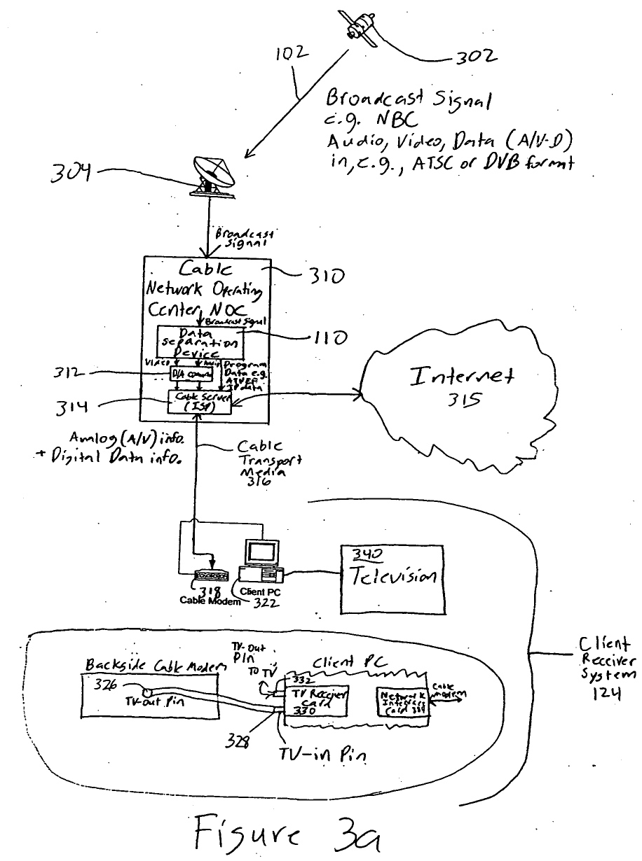

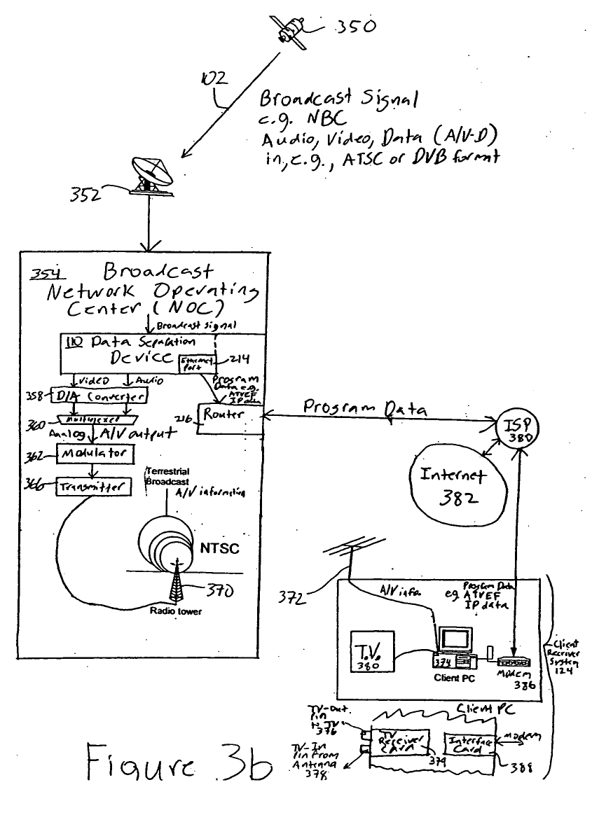

FIG. 3a is a diagram illustrating the data separation device 110 installed within a Cable NOC 310 and particularly illustrates a client receiver system 124 according to one embodiment of the invention. As shown in FIG. 3a, the Cable NOC 310 receives a digital broadcast signal 102 that includes A/V information (e.g. a television program) and data (A/V-D) in, for example, an ATSC or DVB format, from a satellite 302 by utilizing a satellite antenna 304. The digital broadcast signal 102 is separated into digital audio information, digital video information, and digital program data by the data separation device 110, as previously discussed. In this instance, the data separation device 110 includes the router. The router transmits the digital program data (e.g. ATVEF and/or IP data including graphics, video, text, audio, and other types of data) to a cable server 314 that also acts as an Internet Service Provider (ISP) allowing for access to the Internet 315 by the client receiver system 124. Alternatively, the client receiver system 124 can gain access to the Internet 315 via another ISP.

The digital-to-analog (D/A) converter 312 receives and converts the digital audio and video information into analog audio and video (A/V) information, respectively, which is transmitted to the cable server 314. The cable server 314 of the Cable NOC 310 transports the analog audio information, the analog video information, and the digital program data via the cable transport media 316 (e.g. a cable) to the client receiver system 124, as will be discussed in more detail. It should be appreciated that, in other embodiments, the Cable NOC 310 could simply pass on the digital audio and video (A/V) information, without converting it to analog, along with the digital program data, to client receiver systems that are digitally compliant (e.g. digitally compliant cable set-top boxes and televisions or computers with digital receiver cards that allow for ATSC DTV, HDTV, ATVEF broadcasts, etc.).

The client receiver system 124 includes a cable modem 318, a computer such as a personal computer (PC) 322, and a display such as a computer monitor or a television 340. The cable modem 318 is connected to the PC 322 and the PC 322, in turn, is connected to the television 340. The cable modem 318 delivers both digital program data (e.g. ATVEF and/or interactive IP data including graphics, video, text, audio, and other types of data) and the analog A/V information to the PC 322 from the cable server (ISP) 314 via the cable 316. Particularly, the cable modem 318 can route IP Multicast ATVEF data for an ATVEF broadcast.

The cable modem 318 connects to a network interface card 334 of the PC 322 thus establishing a connection for the delivery of digital program data (e.g. ATVEF and/or interactive IP data) from the cable server (ISP) 314, as well as, generally establishing a connection to the Internet 315 via the cable server (ISP) 314 for the bi-directional transmission of data. In connecting the cable modem 318 to the PC 322, the TV-out pin 326 on the backside of the cable modem is connected directly to the TV-in pin 328 on the PC's TV receiver card 330 and the TV-out pin 332 on the TV receiver card 330 is connected to the television 340. However, it should be appreciated that many other configurations are possible. Thus, to select an ATVEF digital broadcast program, for example, a TV tuner is used to select the ATVEF program, the A/V information (i.e. the basic TV program) is separated at the cable NOC 310 and routed down the analog portion (e.g. the analog frequency range) of the cable 316 and the digital data portion (e.g. the IP Multicast ATVEF data) is also separated at the cable NOC 310 and routed down the digital portion (e.g. the digital frequency range) of the cable.

Accordingly, the A/V and digital data portions are separated out by the data separation device 110 and delivered separately to the client receiver system 124, and then recombined at the client receiver system 124. This provides a simple solution to allow cable NOCs, which often completely disregard the digital program data, to instead deliver the digital program data (e.g. the IP Multicast ATVEF data) along with the analog television program to the client receiver system. This dramatically increases the client/television viewer's viewing experience by allowing them to enjoy the enhanced television features brought about by the digital program data, which is information the network broadcaster has incorporated into the original digital broadcast signal for the benefit of the television viewer in the first place.

FIG. 3b is a diagram illustrating the data separation device 110 installed within a Broadcast NOC 354 and particularly illustrates the client receiver system 124 according to one embodiment of the invention. As shown in FIG. 3b, the Broadcast NOC 354 receives a digital broadcast signal 102 that includes A/V information (i.e. a television program) and data (A/V-D) in, for example, an ATSC or DVB format, from a satellite 350 by utilizing a satellite antenna 352. The digital broadcast signal 102 is separated into digital audio information, digital video information, and digital program data by the data separation device 110, as previously discussed. The router 216 transmits the digital program data (e.g. ATVEF and/or IP data including graphics, video, text, audio, and other types of data) to an Internet Service Provide (ISP) 380 for access by the client receiver system 124. The Internet Service Provide (ISP) can also provide access to the Internet 315 for the client receiver system 124. The ISP 380 can be a separate ISP, for example, operated by another company, or the Broadcast NOC 354 can itself contain and/or operate the ISP. Alternatively, a client receiver system may go through another ISP to connect to the ISP 380 associated with the Broadcast NOC 354.

The digital-to-analog (D/A) converter 358 receives and converts the digital audio and digital video information into analog audio and video information, respectively. The analog audio and video (A/V) information is then combined, for example, by a multiplexer 360. A modulator 362 modulates the analog A/V output with a carrier frequency and a transmitter 366 transmits the modulated analog A/V signal to a radio tower 370 that terrestrially broadcasts the A/V signal to client receiver systems. For exemplary purposes, the Network Operating Center (NOC) shown and described is an NTSC broadcast NOC. Thus, the radio tower 370 broadcasts the analog A/V information in the NTSC format to the client receiver system 124 where it is combined with the digital program data (e.g. graphics, video, text, audio, and other types of data) from the ISP 380, as will be discussed in more detail. It should be appreciated that, in other embodiments, the NOC could be an ATSC NOC and could simply pass on the digital audio and video (A/V) information to client receiver systems that are digitally compliant (e.g. digitally compliant cable set-top boxes and televisions or computers with digital receiver cards that allow for ATSC DTV, HDTV, ATVEF broadcasts, etc.).

The client receiver system 124 according to this embodiment of the invention includes an antenna 372, a computer such as a personal computer (PC) 374, a modem 386, and a display such as a computer monitor or a television 380. The antenna 372 connects directly to the PC 374. The antenna is connected directly to the PC's analog TV-in pin 378 on the PC's TV receiver card-379. The modem 386 is connected to the PC 374 and the PC 374, in turn, is connected to the television 380. The modem 386 delivers the digital program data (e.g. ATVEF and/or interactive IP data including graphics, video, text, audio, and other types of data) from the ISP 380 to the PC 374. Particularly, the modem 386 can route IP Multicast ATVEF data for an ATVEF broadcast.

The modem 386 connects to an interface card 388 of the PC 374 thus establishing a connection (e.g. telephone, Digital Subscriber Line (DSL)) for the delivery of digital program data (e.g. ATVEF and/or interactive IP data) from the ISP 380, as well as, generally establishing a connection to the Internet 382 via the ISP 380 for the bi-directional transmission of data. The interface card may, for example, be a peripheral communication interface (PCI) bus card. The PC 374 can be connected to the television 380 for the display of A/V information, as well as, digital program data, by connecting the TV-out pin 376 of the PC's TV receiver card 379 to the television 380. However, it should be appreciated that many other configurations are possible.

For example, to select an ATVEF digital broadcast program a TV tuner is used to select the ATVEF program. The A/V information (i.e. the basic TV program) is separated at the Broadcast NOC 354 and is transmitted over-the-air via an NTSC terrestrial broadcast. Simultaneously, the digital data portion (e.g. the IP Multicast content ATVEF data) is also separated at the Broadcast NOC 354 and is routed via the ISP 380 to the client receiver system 124. Particularly, ATVEF digital data is delivered by the modem 386 which has dialed into the ISP 380 thereby establishing a connection. Thus, the digital data (e.g. the IP Multicast content ATVEF data) is routed down through the modem connection of the PC 374 and displayed with the A/V information on the television 380.

Therefore, the A/V and digital data portions are separated out by the data separation device 110 and delivered separately to the client receiver system 124, and then recombined at the client receiver system. This provides a simple solution to allow Broadcast NOCs, which often completely disregard the digital program data, to instead deliver the digital program data (e.g. the IP Multicast ATVEF data) along with the analog television program to the client receiver system.

To illustrate this, assume a television network transmits a financial news show in an ATVEF broadcast form (including both A/V information (the traditional TV show) along with digital data). For example, the financial news show may include an announcer talking about what happened to the stock market during the day and digital program data (e.g. IP Multicast ATVEF data) including information such as streaming stock quotes, information about a company—e.g. a news story or a picture of the company headquarters, graphs, etc., is to be displayed in a window beneath the announcer. Unfortunately, many Broadcast and Cable NOCs presently completely disregard this digital program data because they are not equipped to pass it on to client receiver systems resulting in it being inaccessible to the TV viewer. However, with present invention, the digital data portion can be readily viewed along with the traditional A/V information (i.e. the financial news show) on analog TV sets in conjunction with a personal computer and a modem. Thus, the present invention enables ATVEF broadcasts without requiring a digital receiver card to view ATVEF programs. Furthermore, the present invention dramatically increases the client/television viewer's viewing experience by allowing them to enjoy the enhanced television features brought about by digital program data, which is information the network broadcaster has incorporated into the original digital broadcast signal for the benefit of the television viewer in the first place.

It should be appreciated that the previously described functional components can be implemented in hardware, software, or a combination of hardware and software. When implemented in software, the elements of the present invention are the code segments to perform the necessary tasks. The program or code segments can be stored in a machine readable medium, such as a processor readable medium, or transmitted by a computer data signal embodied in a carrier wave, or a signal modulated by a carrier, over a transmission medium. The machine-readable medium may include any medium that can store or transfer information in a form readable by a machine (e.g. a processor, a computer, etc.). Examples of the machine-readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

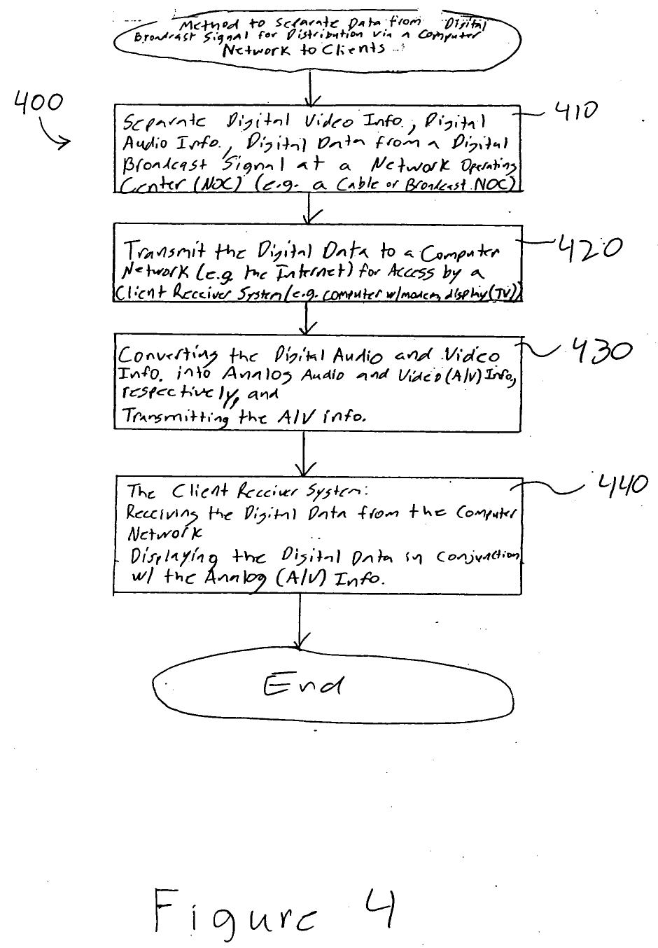

FIG. 4 is a flowchart illustrating a method to separate data from a digital broadcast signal for distribution via a computer network to a client receiver system according to one embodiment of the invention. The process 400 first separates digital video information, digital audio information, and digital program data from a digital broadcast signal at a Network Operating Center (NOC) (e.g. a cable are broadcast NOC) (block 410). Next, the process 400 transmits the digital program data to a computer network (e.g. the Internet) for access by a client receiver system (e.g. a computer with a modem and a display (such as a television)) (block 420). Then, the process 400 converts the digital audio and video (A/V) information into analog (A/V) information, respectively, and transmits the analog A/V information (block 430). The process 400 then utilizes a client receiver system to receive the digital program data from the computer network and to display the digital program data alone or in conjunction with the analog (A/V) information (e.g. a television program) (block 440). The process 400 is then terminated. Thus, the A/V information and the digital program data portions of the digital broadcast signal are separated at the NOC and delivered separately to the client receiver system, at which point they can be recombined for display.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1-40. (canceled)

41. A system comprising:
a Network Operating Center (NOC), including:
a demodulator to demodulate a digital broadcast signal from a carrier frequency, the digital broadcast signal being transmitted from a satellite;
a demultiplexer to separate digital video information, digital audio information, and digital data from the digital broadcast signal;
a router to transmit the digital data received from the demultiplexer through a computer network;
a digital-to-analog (D/A) converter to convert the digital video information and digital audio information into analog video information and analog audio information;
a multiplexer to multiplex the analog audio information and the analog video information into combined analog audio/video (A/V) information; and
a personal computer including a modem coupled the computer network;
wherein the analog A/V information is transmitted through an analog transmission system to an analog TV receiver card of the personal computer and the digital data is routed through the computer network to the modem of the personal computer and wherein the personal computer is coupled to a display device for the display of the analog A/V information in conjunction with the digital data on the display device.

42. The system of claim 41, wherein the digital video information is compatible with a motion pictures experts group (MPEG) standard.

43. The system of claim 42, wherein the digital data is compatible with at least one of advanced television enhancement forum (ATVEF) standard or an Internet Protocol (IP) standard.

44. The system of claim 43, wherein the computer network includes the Internet.

45. The system of claim 44, wherein the network operating center (NOC) is a broadcast NOC and the analog video and analog audio information are transmitted over-the-air to an antenna.

46. The system of claim 45, wherein the antenna is connected to the analog TV receiver card of the personal computer, and the TV receiver card supplies a television with the analog video and audio information from the personal computer as well as digital data from the modem of the personal computer for display by the television.

47. The system of claim 44, wherein the Network Operating Center (NOC) is a cable NOC and the modem of the personal computer is a cable modem, wherein the analog video information and the analog audio information are transmitted to the cable modem through cable transport media, and wherein the TV receiver card of the personal computer supplies a television with the analog video and audio information as well as digital data for display by the television.

48. A method comprising:
demodulating a digital broadcast signal from a carrier frequency at a Network Operating Center (NOC), the digital broadcast signal being transmitted from a satellite;
demultiplexing the digital broadcast signal into separate digital video information, digital audio information, and digital data from the digital broadcast signal;
routing digital data received from the demultiplexer through a computer network;
converting the digital video information and digital audio information into analog video information and analog audio information;
multiplexing the analog audio information and the analog video information into combined analog audio/video (A/V) information; and
wherein the combined analog A/V information is transmitted through an analog transmission system to an analog TV receiver card of a personal computer and the digital data is routed through the computer network to a modem of the personal computer and wherein the personal computer is coupled to a display device for the display of the analog A/V information in conjunction with the digital data on the display device.

49. The method of claim 48, wherein the digital video information is compatible with a motion pictures experts group (MPEG) standard.

50. The method of claim 49, wherein the digital data is compatible with at least one of advanced television enhancement forum (ATVEF) standard or an Internet Protocol (IP) standard.

51. The method of claim 50, wherein the computer network includes the Internet.

52. The method of claim 51, wherein the network operating center (NOC) is a broadcast NOC and the analog video and analog audio information are transmitted over-the-air to an antenna.

53. The method of claim 52, wherein the antenna is connected to the analog TV receiver card of the personal computer, and the TV receiver card supplies a television with the analog video and audio information from the personal computer as well as digital data from the modem of the personal computer for display by the television.

54. The system of claim 51, wherein the Network Operating Center (NOC) is a cable NOC and the modem of the personal computer is a cable modem, wherein the analog video information and the analog audio information are transmitted to the cable modem through cable transport media, and wherein the TV receiver card of the personal computer supplies a television with the analog video and audio information as well as digital data for display by the television.

55. A system comprising:
a broadcast NOC Network Operating Center (NOC), comprising:
a demodulator to demodulate a digital broadcast signal from a carrier frequency, the digital broadcast signal being transmitted from a satellite;
a demultiplexer to separate digital video information, digital audio information, and digital data from the digital broadcast signal, wherein the digital video information is compatible with a motion pictures experts group (MPEG) standard and the digital data is compatible with at least one of advanced television enhancement forum (ATVEF) standard or an Internet Protocol (IP) standard;
a router to transmit the digital data received from the demultiplexer through a computer network;
a digital-to-analog (D/A) converter to convert the digital video information and digital audio information into analog video information and analog audio information;
a multiplexer to multiplex the analog audio information and the analog video information into combined analog audio/video (A/V) information, wherein the analog video and analog audio information are transmitted over-the-air; and
a personal computer including a modem coupled the computer network;
wherein the analog A/V information is transmitted through an analog transmission system over-the-air to an antenna coupled to an analog TV receiver card of the personal computer and the digital data is routed through the computer network to a modem of the personal computer and wherein the personal computer is coupled to a display device for the display of the analog A/V information in conjunction with the digital data on the display device.

56. The system of claim 55, wherein the computer network includes the Internet.

57. The system of claim 56, wherein the antenna is connected to the analog TV receiver card of the personal computer, and the TV receiver card supplies a television with the analog video and audio information from the personal computer as well as digital data from the modem of the personal computer for display by the television.
